(19) United States
(12) Patent Application Publication
(10) Pub. No.: US 2007/0019242 A1
(43) Pub. Date: Jan. 25, 2007

(54) Image processing apparatus and image processing method

(75) Inventor: Masatsugu Hirayama, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/186,972

(22) Filed: Jul. 22, 2005

(51) Int. Cl. G06F 15/00; G06K 15/00

(52) U.S. Cl. 358/3.24; 358/448; 358/1.9

(57) ABSTRACT

An image processing apparatus having a read unit which reads an image of a document to output an image signal, an identification unit which performs image area identification of a character area and a background area based on the image signal read by the read unit, a non-character filter unit which performs a non-character filter process to the image signal read by the read unit, the non-character filter unit outputting the image signal to which the non-character filter process is performed, a character filter unit which performs a character filter process to the image signal read by the read unit, the character filter unit outputting the image signal to which the character filter process is performed, a comparison unit which compares the image signal from the read unit and the character-filter-processed image signal from the character filter unit, and a control unit which outputs the non-character-filter-processed image signal from the non-character filter unit when the identification unit determines that the image signal is the background area, the character-filter-processed image signal to be output from the character filter unit when the identification unit determines that the image signal is the character area and the comparison result of the comparison unit shows a first predetermined result, the control unit controlling the image signal to be output from the read unit when the identification unit determines that the image signal is the character area and the comparison result of the comparison unit shows a second predetermined result different from the first predetermined result.

### BACKGROUND OF THE INVENTION

The present invention relates to an image processing apparatus and an image processing method for processing a document image. Particularly the invention relates to the image processing apparatus and the image processing method for suppressing a white border in which an edge portion of a character having a certain density level on a ground comes off white. The white border is generated by a filter process such as an edge process. An image forming apparatus, in which the image processing apparatus and the image processing method are used, is also disclosed.

Recently, as performance of the image forming apparatus such as a digital copying machine is improved, an integrated digital instrument which has the copying function and a printer function is developed and becomes widespread. The further improvement of each function is demanded in the image forming apparatus.

In an image forming apparatus disclosed in Jpn. Pat. Appln. KOKAI Publication No. 2001-103312, the edge process is adjusted according to a color image and a monochrome image because the color image and the monochrome image differ from each other in influence of the edge process.

However, for example with reference to a background area of a character image, the influence of the actual edge process emerges in the image forming apparatus such that highlighting process performed by the edge process generates undershooting in a boundary portion between the character and the ground to create the white border in which the edge portion of the character comes off white, when an image identified as a character portion by image area identification belongs to a part of the character on the ground having a certain density level. In the conventional image forming apparatus, there is a problem that provision for the white border cannot be made according to the background image.

### BRIEF SUMMARY OF THE INVENTION

There is provided an image processing apparatus comprising: a read unit which reads an image of a document to output an image signal; an identification unit which performs image area identification of a character area and a background area based on the image signal read by the read unit; a non-character filter unit which performs a non-character filter process to the image signal read by the read unit, the non-character filter unit outputting the image signal to which the non-character filter process is performed; a character filter unit which performs a character filter process to the image signal read by the read unit, the character filter unit outputting the image signal to which the character filter process is performed; a comparison unit which compares the image signal from the read unit and the character-filter-processed image signal from the character filter unit; and a control unit which controls the non-character-filter-processed image signal to be output from the non-character filter unit when the identification unit determines that the image signal is the background area, the character-filter-processed image signal to be output from the character filter unit when the identification unit determines that the image signal is the character area and the comparison result of the comparison unit shows a first predetermined result, the image signal to be output from the read unit when the identification unit determines that the image signal is the character area and the comparison result of the comparison unit shows a second predetermined result different from the first predetermined result.

### BRIEF DESCRIPTION OF THE SEVERAL VIEWS OF THE DRAWING

FIG. 1 is a block diagram showing an example of a configuration of an image forming apparatus according to an embodiment of the invention;

FIG. 2 is a graph showing an example of a frequency characteristic for explaining a filter process of the image forming apparatus;

FIG. 3 is a graph showing an example of a signal change before and after the filter process of the image forming apparatus;

FIG. 4 is a graph showing an example of a change in character on a ground after the filter process of the image forming apparatus;

FIG. 5 is a block diagram for explaining a relationship between an image area identification unit and a filter unit in the image forming apparatus;

FIG. 6 is an explanatory view showing an example of the change in character on the ground by the filter process of the image forming apparatus; and

FIG. 7 is a flowchart showing an example of the filter process of the image forming apparatus.

### DETAILED DESCRIPTION OF THE INVENTION

An image forming apparatus and an image forming method according to an embodiment of the invention will de described in detail with reference to the accompanying drawings.

In the image forming apparatus of the embodiment, for example, when the white border in which the edge portion of the character comes off is generated, i.e. when the image density after the filter process is lowered compared with the image density before the filter process, it is assumed that the white border is generated and the image is directly supplied from a scanner unit.

<Image Forming Apparatus according to Embodiment of the Invention>

(Configuration)

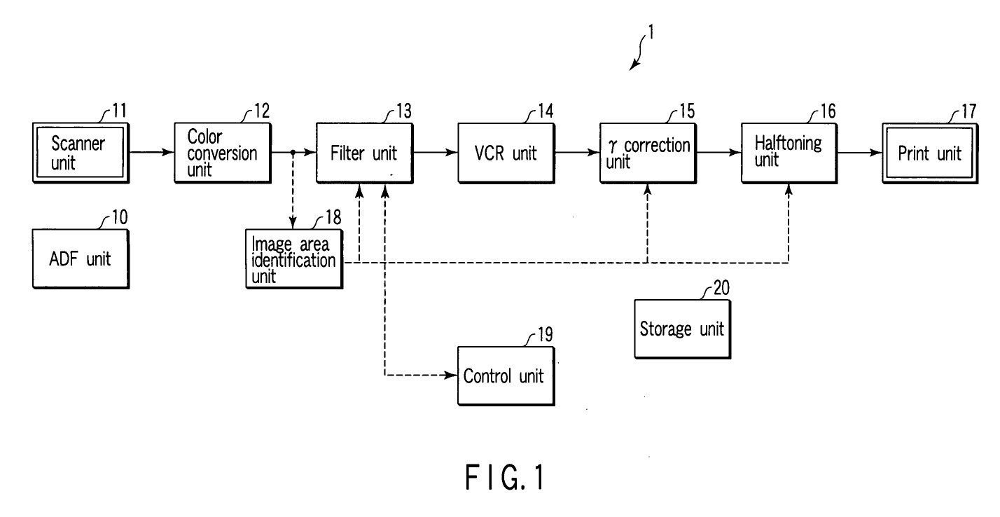

FIG. 1 is a block diagram showing an example of a configuration of the image forming apparatus according to the embodiment of the invention. Referring to FIG. 1, an image forming apparatus 1 includes an ADF unit 10, a scanner unit 11, a color conversion unit 12, a filter unit 13, a VCR (Vender Color Removal) unit 14, a γ correction unit 15, a halftoning unit 16, and a print unit 17. The ADF unit 10 automatically conveys a document. The scanner unit 11 inputs an image signal. The color conversion unit 12 receives output of the scanner unit 11. The filter unit 13 receives the image signal after the color conversion to perform the filter process. The VCR unit 14 performs a VCR process to the image signal to which the filter process has been performed. The γ correction unit 15 performs γ correction to the image signal to which the VCR process has been performed. The halftoning unit 16 performs a gradation process to the image signal to which the γ correction has been performed. The print unit 17 forms the image on a recording medium according to the image signal to which the gradation process has been performed. The image forming apparatus 1 further includes an image area identification unit 18, a control unit 19, and a storage unit 20. The image area identification unit 18 receives the output from the color conversion unit 12 to perform the image area identification, and the image area identification unit 18 supplies an image area identification signal to the filter unit 13, the γ correction unit 15, and the halftoning unit 16. The control unit 19 controls the whole of process actions. The storage unit 20 has a storage area in which an action program, the image signal to be processed, and the like are stored.

The following basic actions are performed in the image forming apparatus 1 having the above configuration. When the document is read by the scanner unit 11, an RGB image signal is transmitted to the color conversion unit 12. The RGB image signal inputted to the color conversion unit 12 is converted into a CMY signal which has recording colors. The image area identification unit 18 determines whether a target pixel in the original image is the character portion or not based on the inputted CMY signal, and the image area identification unit 18 determines whether the target pixel has the white ground or the background. Then, the image area identification unit 18 outputs the determination results as the image area identification signal (with reference to the ground determination technology, for example, see Jpn. Pat. Appln. KOKAI Publication No. 2002-330285). The image signal outputted from the color conversion unit 12 is switched by the filter unit 13 according to the image area identification signal. Then, the VCR unit 14 generates a black signal from the CMY image signal and outputs a CMYK image signal. The γ correction unit 15 receives the CMYK signal, and the γ correction unit 15 corrects the gradation according to the image area identification signal to output the corrected CMYK signal. The output data of the CMYK signal and the image area identification signal are converted into print data by the halftoning unit 16 and supplied to the print unit 17 which is of the image forming unit, and the image is formed on the recording medium.

<Filter Process according to Embodiment of the Invention>

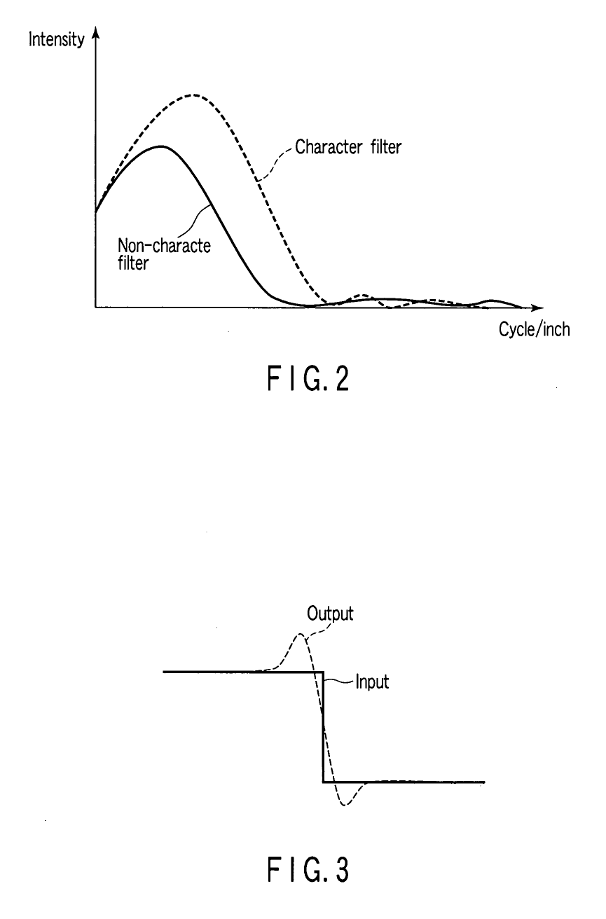

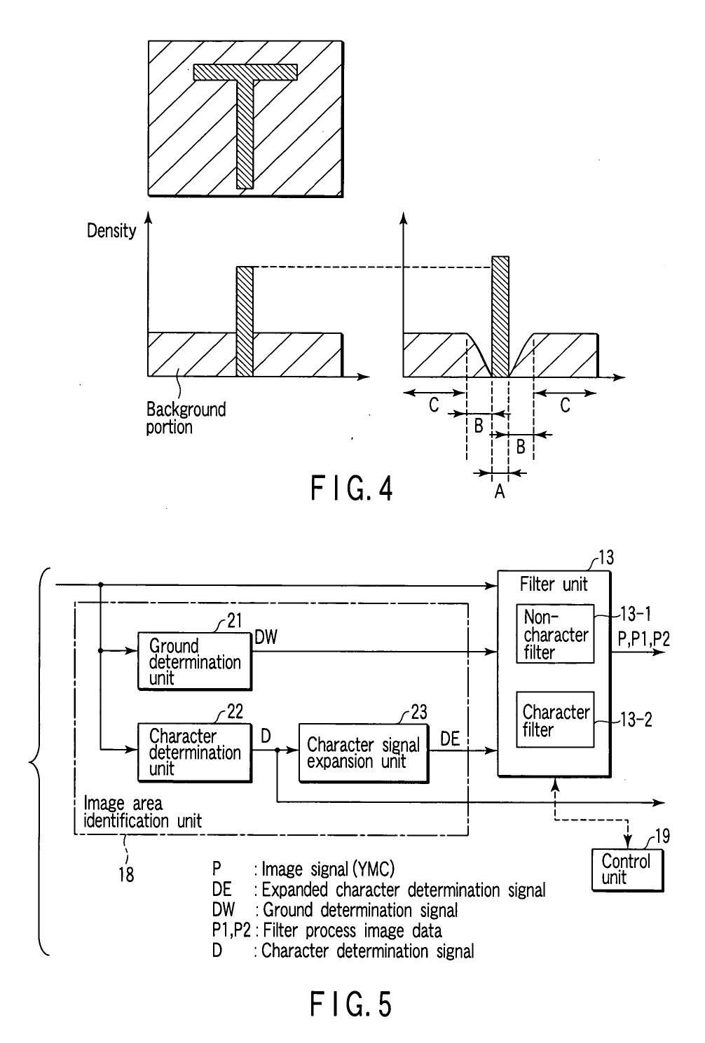

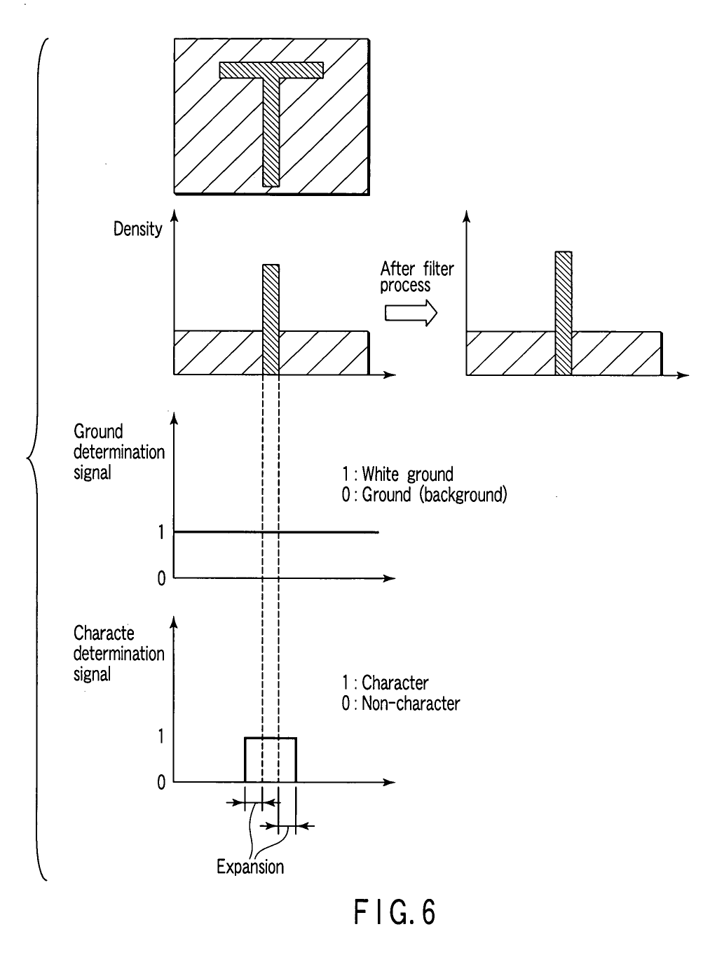

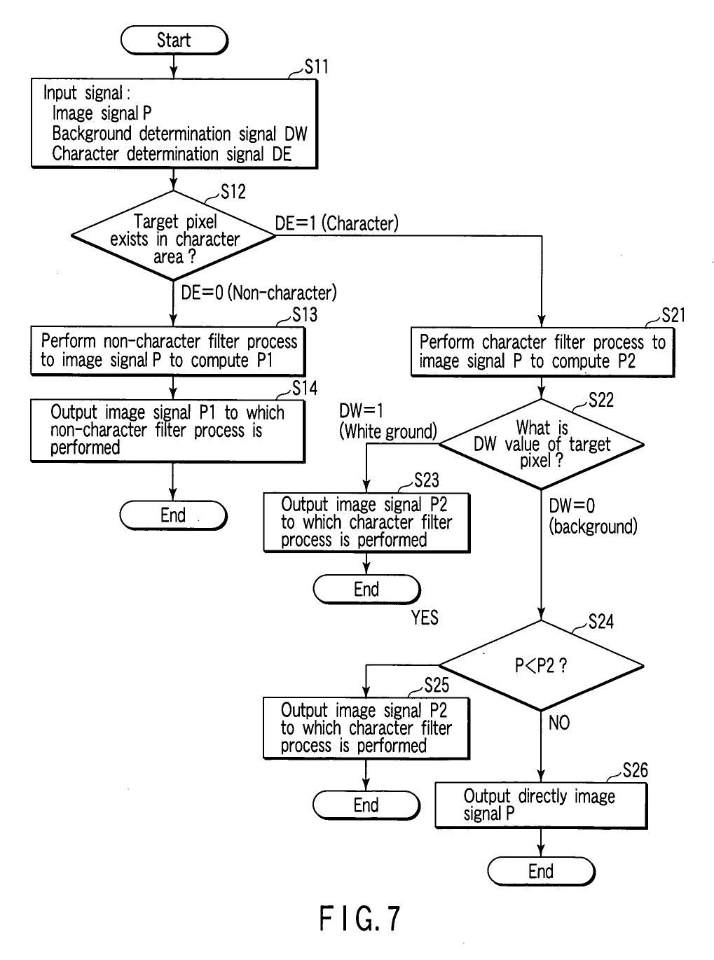

Then, the filter process depending on an area type in the image forming apparatus according to the embodiment of the invention will be described with reference to the drawings including a flowchart. FIG. 2 is a graph showing a frequency characteristic for explaining an example of the filter process of the image forming apparatus, FIG. 3 is a graph showing an example of a signal change before and after the filter process of the image forming apparatus, FIG. 4 is an example of a graph showing a change in character on the ground after the filter process of the image forming apparatus, FIG. 5 is a block diagram for explaining an example of a relationship between an image area identification unit and a filter unit in the image forming apparatus, FIG. 6 is an explanatory view showing an example of the change in character on the ground by the filter process of the image forming apparatus, and FIG. 7 is a flowchart showing an example of the filter process of the image forming apparatus.

(General Outline)

A general outline of the filter process according to the embodiment will first be described. As shown in FIG. 2, the process is performed with a character filter for sharpening the character with respect to the pixel which is detected as the character by the image area identification, and the process is performed with a non-character filter for removing moire and the like with respect to the pixel other than the character pixel.

In the filter process, assuming that a filter coefficient is I_{0,0}, when a reference area is set at 7×7 for the target pixel Pᵢⱼ, an output value I′_{0,0} after the filter process is given by the following equation:
I′_{0,0}=Σ(i=3 to i=−3)·Σ(j=3 to j=−3)·Pᵢⱼ×Iᵢⱼ

At this point, when the sharpening (highlighting) is performed to the character and a narrow line by the filter process, the density is change in the edge portion as shown in FIG. 3. However, as shown in FIG. 4, when the edge process is performed to the character on the ground (background) having a certain density level, the ground density is decreased near the edge portion of the character, which sometimes generates the white border on a periphery of the character as the output result. That is, in FIG. 4, an area C is the normal background area where the problem does not exist, an area B is one where the white border is generated, and an area C is the normal character area where the problem does not exist.

In order to suppress the white border, the image area identification unit 18 and the filter unit 13 in the image forming apparatus 1 according to the invention has the following characteristic configuration.

As shown in FIG. 5, the image area identification unit 18 includes a ground determination unit 21, a character determination unit 22, and a character signal expansion unit 23. The ground determination unit 21 and the character determination unit 22 perform the determination to the input signal P (=C, M, and Y). The character signal expansion unit 23 receives the output of the character determination unit 22 to expand the character signal by a predetermined width as shown in FIG. 6, and the character signal expansion unit 23 outputs an expanded character determination signal DE. As can be seen from FIG. 6, after the character area of the document image is expanded by the character signal expansion unit 23 of FIG. 5, then the expanded character determination signal DE is outputted. It is possible that a user arbitrarily gives a degree of the expansion from an operation unit (not shown) through the control action by the control unit 19.

In this case, a ground determination signal DW and the expanded character determination signal DE are outputted as the image area determination signal. A character determination signal D outputted to the filter unit 13 is converted by the character signal expansion unit 23 into the expanded character determination signal DE which is expanded by the specified number of pixels toward the periphery. This is performed to obtain a compensation effect to the white border problem in the later-mentioned filter unit 13. The filter unit 13 has at least a non-character filter 13-1 and a character filter 13-2. The filter unit 13 switches the process according to the image area identification signal D, DE as follows. The non-character filter 13-1 is for example the filter for processing the gradation portion. The character filter 13-2 is for example the filter for performing the filtering process.

When the image area identification unit 18 determines that the image signal is the background area by the ground determination signal DW, the non-character filter 13-1 outputs the image signal to which the non-character filter process is performed.

The image area identification unit 18 determines that the image signal is the character area, and the comparison result between the outputs of non-character filter 13-1 and the character filter 13-2 through the comparison process in the control unit 19 shows that the density after the image formation is higher than the density before the filter process in the image signal to which the character filter process is performed. Then, the character filter 13-2 outputs the image signal to which the character filter process is performed.

Further, the image area identification unit 18 determines that the image signal is the character area, and the comparison result of the control unit 19 shows that the density after the image formation is lower than the density before the filter process in the image signal to which the character filter process is performed, namely, the control unit 19 determines that the white border is generated. Then, the control is performed such that the scanner unit 11 outputs the image signal, which allows the white border to be avoided.

(Description on Filter Process With Flowchart)

Then, an example of the filter process action of the image forming apparatus 1 according to the invention will be described in detail with reference to a flow chart of FIG. 7.

For example, the image forming apparatus 1 can be realized by the control unit 19 and an action program stored in the storage unit 20. First the document is captured by scanner unit 11. Then, the color conversion unit 12 performs the color conversion to the RGB signal, and the color conversion unit 12 converts the image signal P which is of the RGB signal into the CMY signal. While the image signal P is supplied to the filter unit 13, the image signal P is supplied to the ground determination unit 21 and the character determination unit 22 in the image area identification unit 18. The image area identification unit 18 supplies the ground determination signal DW and the expanded character determination signal DE to the control unit 19 (Step S11).

The control unit 19 determines whether the target image is the character area or not (Step S12). When the control unit 19 determines that the target pixel is the non-character area (DE=0), the non-character filter process is performed to the image signal P to compute the image signal P1, and the control unit 19 controls a switching function (not shown) of the filter unit 13 to output the image signal P1 in order to supplies the image signal P1 to the post-stage VCR unit 14 (Step S13 and S14).

The VCR unit 14 generates the black signal from the CMY image signal to output the CMYK signal. The γ correction unit 15 receives the CMYK signal, and the γ correction unit 15 corrects the gradation according to the image area identification signal to output the corrected CMYK signal. The halftoning unit 16 converts the output data of the CMYK signal and the image area identification signal into the print data to supply the print data to the print unit 17 which is of the image forming unit, and the image is formed on the recording medium.

In Step S12, when the control unit 19 determines that the target image is the character area (DE=1), the image signal P2 which is of the output of the character filter 13-2 is used as the YMC image signal to be outputted (Step S21). When the target pixel is the white ground (DW=1) (Step S22), in order to selectively supply the image signal P2 which is of the output of the character filter 13-2 to the post-stage VCR unit 14, the control unit 19 controls the switching function (not shown) of the filter unit 13 (Step S23).

When the target pixel is the background (DW=0) (Step S22), magnitude of the image signal P2 of the character filter 13-2 and magnitude of the image signal P from the color conversion unit 12 are compared to each other (Step S24). In step S24, when the image signal from the read unit is compared with the character-filter-processed image signal from the character filter unit, in case that it is not determined that the image signal P2 to which the character filter process has been performed is higher than the image signal of the pre-filter process in the image density of the post-image formation, namely, when the image signal P is lower than the image signal P2, the control is performed such that the filter unit 13 selectively outputs the image signal P2 of the character filter 13-2 (Step S25). Accordingly, the image signal to which the normal character filter process is performed is outputted to the post stage and supplied to the print unit 17 through the VCR unit 14, the γ correction unit 15, and the halftoning unit 16.

On the other hand, in Step S24, when it is determined that the image signal P2 to which the character filter process has been performed is lower than the image signal of the pre-filter process in the image density of the post-image formation, namely, when the image signal P is not lower than the image signal P2, the control is performed such that the image signal P from the color conversion unit 12 is selectively used and outputted to the post stage without passing the image signal P through the filter in the filter unit 13 (Step S26). Accordingly, since the character filter process is not performed to the target pixel, the generation of the white border shown in FIG. 4 can selectively be prevented to reproduce the image with good quality.

As described above, those skilled in the art can be realized the invention by the embodiment. However, it is to be understood that various modifications will be apparent to those skilled in the art without departing from the spirit and scope of the invention. Accordingly, the invention should cover a wide range consistent with the disclosed principles and novel features, and the invention is not limited to the above-described embodiment.

What is claimed is:

1. An image processing apparatus comprising:
a read unit which reads an image of a document to output an image signal;
an identification unit which performs image area identification of a character area and a background area based on the image signal read by the read unit;
a non-character filter unit which performs a non-character filter process to the image signal read by the read unit, the non-character filter unit outputting the image signal to which the non-character filter process is performed;
a character filter unit which performs a character filter process to the image signal read by the read unit, the character filter unit outputting the image signal to which the character filter process is performed;
a comparison unit which compares the image signal from the read unit and the character-filter-processed image signal from the character filter unit; and
a control unit which controls the non-character-filter-processed image signal to be output from the non-character filter unit when the identification unit determines that the image signal is the background area, the character-filter-processed image signal to be output from the character filter unit when the identification unit determines that the image signal is the character area and the comparison result of the comparison unit shows a first predetermined result, the image signal to be output from the read unit when the identification unit determines that the image signal is the character area and the comparison result of the comparison unit shows a second predetermined result different from the first predetermined result.

2. An image processing apparatus according to claim 1, wherein the comparison unit compares the image signal from the read unit and the character-filter-processed image signal from the character filter unit, and the comparison unit supplies the second predetermined result to the control unit when it is determined that the character-filter-processed image signal is lower than the pre-filter-processed image signal in image density of post-image formation.

3. An image processing apparatus according to claim 1, further comprising an image forming unit which receives the image signal outputted under the control of the control unit, the image forming unit forming the image on a recording medium.

4. An image processing apparatus according to claim 1, wherein the identification unit expands the character area to an area wider than the area which is determined as the character area by the identification unit, and the identification unit sets the wider area at the character area.

5. An image processing apparatus according to claim 4, wherein a degree of the expansion is changed according to operation in the area expansion by the identification unit.

6. An image processing method comprising:
reading an image of a document to output an image signal;
performing image area identification of a character area and a background area based on the read image signal;
performing a non-character filter process to the image signal to output the non-character-filter-processed image signal;
performing a character filter process to the image signal to output the character-filter-processed image signal;
comparing the image signal and the character-filter-processed image signal; and
controlling the non-character-filter-processed image signal to be output when it is determined that the image signal is the background area, the character-filter-processed image signal to be output when it is determined that the image signal is the character area and the comparison result shows a first predetermined result, and the image signal to be output when it is determined that the image signal is the character area and the comparison result shows a second predetermined result different from the first predetermined result.

7. An image processing method according to claim 5, wherein the comparing process compares the image signal and the character-filter-processed image signal, and the comparing process supplies the second predetermined result when it is determined that the character-filter-processed image signal is lower than the pre-filter-processed image signal in image density of post-image formation.

8. An image processing method according to claim 5, further comprising receiving the image signal, finally outputted as a result of control, to form the image on a recording medium according to the image signal.

9. An image processing method according to claim 5, wherein the identifying process includes expanding the character area to an area wider than the area which is determined as the character area by the identification unit,_and supplying the identification signal which is set to the wider area at the character area.

10. An image processing method according to claim 9, wherein a degree of the expansion of the area is changed according to operation in the area expansion.
